(19) United States
(12) Patent Application Publication
(10) Pub. No.: US 2016/0186955 A1
(43) Pub. Date: Jun. 30, 2016

(54) ADAPTIVE HEADLIGHT ASSEMBLY

(71) Applicant: NATIONAL CENTRAL UNIVERSITY, Taoyuan County (TW)

(72) Inventors: CHING-CHERNG SUN, TAOYUAN COUNTY (TW); JHIH-YOU CAI, TAOYUAN COUNTY (TW); MIAN-RU CHENG, TAICHUNG CITY (TW); YI-CHIEN LO, MIAOLI COUNTY (TW)

(21) Appl. No.: 14/837,263

(22) Filed: Aug. 27, 2015

(30) Foreign Application Priority Data
Dec. 31, 2014 (TW) 103146604

(51) Int. Cl. F21S 8/10; F21K 99/00

(52) U.S. Cl. CPC F21S 48/1757; F21S 48/1154; F21S 48/1233; F21S 48/1388; F21K 9/56; F21Y 2101/02

(57) ABSTRACT

An adaptive headlight assembly includes a light source with two reflection members located on two sides thereof and extending forward. The light source has multiple light emitting members which are arranged in rows. Each of the two reflection members is located at an angle relative to the light source. An opening is defined between the two reflection members and the light source. A lens is located in front of the opening. The light rays emitted from the light emitting members are partially reflected by the two reflection members, and partially pass through the lens. The height and the angular positions of the two reflection members provide different illumination areas of different widths.

### BACKGROUND OF THE INVENTION

1. Fields of the Invention

The present invention relates to a headlight assembly, and more particularly, to an adaptive headlight assembly which provides high illumination feature without using too many light members.

2. Descriptions of Related Art

The conventional headlight assemblies for vehicles are designed to provide sufficient illumination feature for the drivers. There are the low beam and the high beam provided for the conventional headlight assembly so as to allow the driver to see clearly the conditions of the road at different distances. However, when the vehicle is driving on an up-hill road or turns, the conventional headlight assembly cannot completely illuminate the road ahead so that the adaptive headlight assembly is developed.

The conventional adaptive headlight assembly uses block plate to adjust the area that the light beam illuminates by mechanical way, and there are many parts involved in the mechanical structure for adjust the light beam properly so that the conventional adaptive headlight assembly is heavy. A known conventional adaptive headlight assembly comprises a base board which has a left area, a central area and a right area, each area is a curved area, and each area is provided with Light Emitting Diodes (LEDs). The base board is connected with a power source so as to be rotated so that the LEDs at different areas are activated when needed. However, the LEDs have to be installed to each area, in other words, if the headlight assembly can illuminate more areas, the number of LEDs has to increase.

Another conventional adaptive headlight assembly comprises at least one module having a mirror with a reflective surface and an opening, LEDs, focusing members, a block plate, and a lens. The mirror has a paraboloid surface and the LEDs are located at the focus of the paraboloid surface. The light rays form the LEDs are reflected and passes through the focusing members are partially focused at the focusing members. The block plate is located at the focuses of the focusing members, and between the lens and the focusing members. More functions require more modules which cause complication of operation and cooperation.

The present invention intends to provide an adaptive headlight assembly to eliminate the shortcomings mentioned above.

### SUMMARY OF THE INVENTION

The present invention relates to an adaptive headlight assembly and comprises a light unit having a light source and two reflection members which are located on two sides of the light source and extend forward. The light source has multiple light emitting members which are arranged in rows. Each of the two reflection members is located at an angle relative to the light source. An opening is defined between the two reflection members and the light source. A lens is located in front of the opening and the light rays emitted from the light emitting members are partially reflected by the two reflection members, and partially pass through the lens so as to provide different illumination areas of different widths.

Preferably, the angle between each of the two reflection members and the light source is defined as θ which is 0 to 10 degrees.

Preferably, the height of each of the two reflection members is defined as D and the width of the light source is defined as d, wherein D=0.5d to 2d.

Preferably, the height of each of the two reflection members is defined as D and the width of the light source is defined as d, wherein D=0.5d to 2d.

Preferably, the light source has a fluorescent powder layer coated thereon which faces the opening.

Preferably, an electric control device is connected to the light source so as to control operation of the light emitting members.

Preferably, the lens is a non-spherical lens, the light emitting members are white-light Light Emitting Diodes.

The primary object of the present invention is to provide an adaptive headlight assembly which does not need too many LEDs to be installed.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates the operation of the adaptive headlight assembly of the present invention;

FIG. 2 shows the light source of the adaptive headlight assembly of the present invention;

FIG. 3 shows the adjustment of the two reflection members of the adaptive headlight assembly of the present invention;

FIG. 4 shows the first illumination pattern of the adaptive headlight assembly of the present invention;

FIG. 5 shows the second illumination pattern of the adaptive headlight assembly of the present invention, and

FIG. 6 shows the third illumination pattern of the adaptive headlight assembly of the present invention.

### DETAILED DESCRIPTION OF THE PREFERRED EMBODIMENT

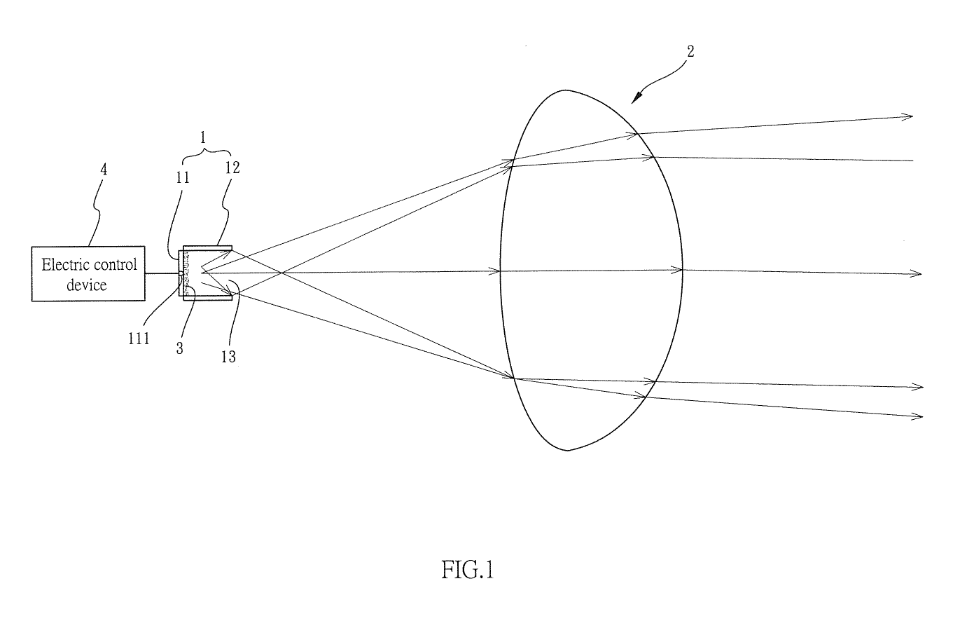

Referring to FIGS. 1 to 6, the adaptive headlight assembly of the present invention comprises a light unit 1 and a lens 2, wherein the light unit 1 comprises a light source 11 and two reflection members 12. The light source 11 has multiple light emitting members 111 which are arranged in rows or arrays. The two reflection members 12 are located on two sides of the light source 12 and extend forward. Each of the two reflection members 12 is located at an angle relative to the light source 11. An opening 13 is defined between the two reflection members 12 and the light source 11. The lens is located in front of the opening and the light rays emitted from the light emitting members 111 are partially reflected by the two reflection members 12, and partially pass through the lens so as to provide different illumination areas of different widths.

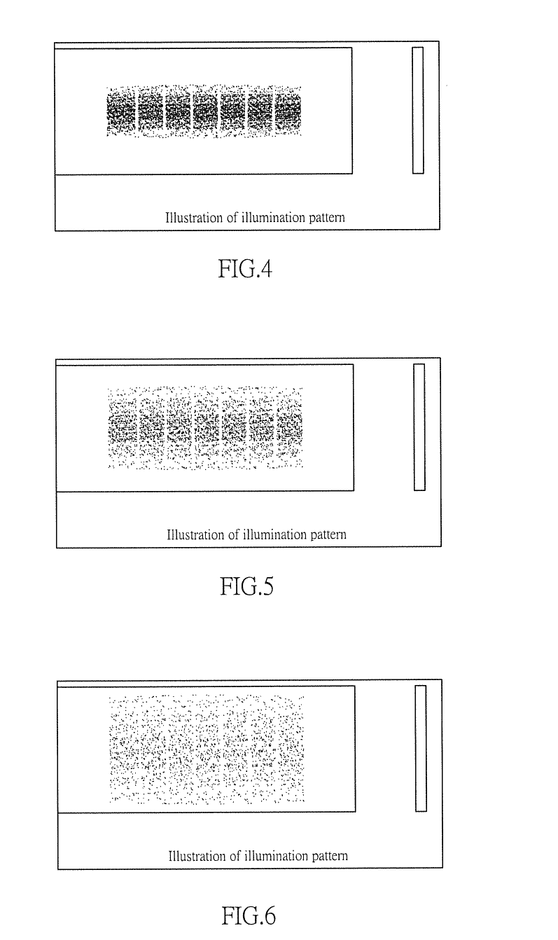

As shown in FIGS. 4 to 6, because the reflection members 12 are located at an angle relative to the light source 11, so that some of the light rays from the light emitting members 111 will be reflected toward the lens 2, and some of the light rays from the light emitting members 111 directly pass through the lens 2. The illumination patterns will be varied according to the length of the reflection members 12, while the optical efficiency is remained.

In detail, the angle between each of the two reflection members 12 and the light source 11 is defined as θ which is 0 to 10 degrees. The height of each of the two reflection members 12 is defined as D and the width of the light source 11 is defined as d, wherein D=0.5d to 2d. When the d is 5 cm, the D will be between 2.5 cm to 10 cm. By adjusting the width of the light source 11 and the height of the reflection members 12, the illumination area can be adjusted in longitudinal direction.

The adjustment to θ will change the centration of the illumination. Assume the θ is 0 degree, the light rays from the light emitting members 111 are centrally collected and pass through the lens 2, so that the light beam is bright and solid. When the θ is 10 degree, the light rays from the light emitting members 111 are not centrally collected and pass through the lens 2, so that the light beam is less bright and weak. Therefore, the light beams from the adaptive headlight assembly of the present invention can be adjusted by changing the angle θ.

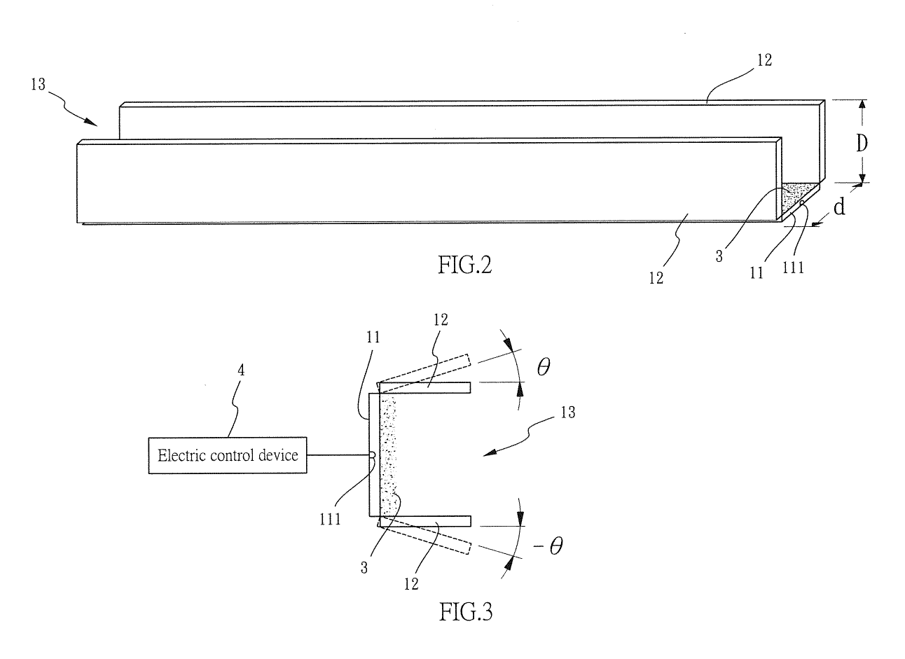

Preferably, the light source 11 has a fluorescent powder layer 3 coated thereon which faces the opening 13. The fluorescent powder layer 3 affects the angle that the light rays pass through the lens 2 to adjust the range of the illumination. As shown in FIGS. 1 and 2, an electric control device 4 is connected to the light source 11 so as to control operation of the light emitting members 111 and save energy.

Preferably, the lens 2 is a non-spherical lens, and the light emitting members 111 are white-light Light Emitting Diodes. The white-light Light Emitting Diodes have longer service life and more environmentally friendly.

The present invention can easily change the illumination areas by adjusting the height and length of the reflection members 12 relative to the light source 11, so that the number of the light emitting members 111 needed can be reduced while the optical features are maintained the same. The present invention also provides different illumination patterns and the headlight assembly is light in weight.

While we have shown and described the embodiment in accordance with the present invention, it should be clear to those skilled in the art that further embodiments may be made without departing from the scope of the present invention.

What is claimed is:

1. An adaptive headlight assembly comprising:
a light unit having a light source and two reflection members, the light source having multiple light emitting members which are arranged in rows, the two reflection members located on two sides of the light source and extending forward, each of the two reflection members being located at an angle relative to the light source, an opening defined between the two reflection members and the light source, and
a lens located in front of the opening, light rays emitted from the light emitting members partially reflected by the two reflection members, and partially passing through the lens, different illumination areas of different longitudinal widths being obtained through the two reflection members.

2. The assembly as claimed in claim 1, wherein the angle between each of the two reflection members and the light source is defined as θ which is 0 to 10 degrees.

3. The assembly as claimed in claim 1, wherein a height of each of the two reflection members is defined as D, a width of the light source is defined as d, D=0.5d to 2d.

4. The assembly as claimed in claim 2, wherein a height of each of the two reflection members is defined as D, a width of the light source is defined as d, D=0.5d to 2d.

5. The assembly as claimed in claim 1, wherein the light source has a fluorescent powder layer coated thereon which faces the opening.

6. The assembly as claimed in claim 1, wherein an electric control device is connected to the light source so as to control operation of the light emitting members.

7. The assembly as claimed in claim 5, wherein an electric control device is connected to the light source so as to control operation of the light emitting members.

8. The assembly as claimed in claim 1, wherein the lens is a non-spherical lens, the light emitting members are white-light Light Emitting Diodes.
